(19) United States
(12) Patent Application Publication
(10) Pub. No.: US 2012/0277955 A1
(43) Pub. Date: Nov. 1, 2012

(54) DRIVING ASSISTANCE DEVICE

(76) Inventor: Yoshiaki Irie, Chiryu-shi (JP)

(21) Appl. No.: 13/376,601

(22) PCT Filed: Dec. 28, 2009
(86) PCT No.: PCT/JP2009/071781

§ 371 Date: Dec. 7, 2011

(51) Int. Cl. G06F 7/00; B62D 6/00; G01C 21/00

(52) U.S. Cl. 701/41; 701/400; 701/1

(57) ABSTRACT

Based on a requested target input by the driver using input means 14 (such as a destination, a travel method to the destination, for example, whether time is a priority or a fuel consumption is a priority), the driver plan creating ECU 1 selects the travel path based on the map information stored in map DB 13 and the current positional information of the vehicle obtained by the GPS 12. Additionally, the path information of the selected path is obtained, and the target track of the vehicle on the selected path is calculated. The variable area which is variable range of the calculated tracking based on the path information is obtained. The driving control ECU 2 uses the variable area information at the time of vehicle control.

### TECHNICAL FIELD

The present invention relates to a driving assistance device mounted on a vehicle for supporting driver's driving manipulation, and more particularly, to a driving assistance device that supports travel according to the established travel track.

### BACKGROUND ART

Recently, a navigation device for providing path guidance to a driver during vehicle travel has become widespread. By using such a navigation device, it is possible to obtain the path information in advance and usefully use the path information in the vehicle control or the like. The technique disclosed in Patent Literature 1 is an example of such techniques, in which the curvature radius R of the scheduled travel line is selected within a range of a curvature radius Rroad of the curved road and the maximum curvature radius Rmax by considering the road width of the curved lane in front and the curved shape and the target vehicle velocity V is set by reflecting this scheduled travel line. If the vehicle velocity seems to surpass the target vehicle velocity V when entering a curve on a road, system urges a driver to decelerate the vehicle and promote safety of travel.

### CITATION LIST

[Patent Literature 1] Japanese Unexamined Patent Application Publication No. 11-328596

### SUMMARY OF INVENTION

### Technical Problem

In the driving assistance of the related art, a control/support is performed to obtain the vehicle behavior optimally validated by the driving assistance device side. However, such control/support does not always correspond with a driver's general manipulation performed without such control/support. In addition, the driving assistance device does not always recognize overall surrounding situations. Therefore, there are cases where a driver may feel uncomfortable with the control/support, the control/support conflicts with the driver's own manipulation, or it may be difficult to perform a cooperative control between a plurality of supports.

In this regard, the present invention provides a driving assistance device capable of facilitating manipulation thereof or cooperation between a plurality of supports without the driver feeling uncomfortable.

### Solution to Problem

In order to solve the aforementioned problems, the driving assistance device according to the present invention includes: path target acquisition means for obtaining a path requested by the driver at the time of travel path setting; path selection means for selecting a travel path according to the obtained target; path information acquisition means for obtaining path information of the selected path; target track calculation means for calculating a target track of a vehicle on the selected path; and variable area calculation means for obtaining a variable area which is a variable area of the track calculated based on the path information.

The driving assistance device may further include driver's intention detection means for detecting driver's intention, wherein the driving assistance may be performed based on the detected driver's intention and the obtained variable area, or the calculated target track may be modified based on the detected driver's intention and the obtained variable area. Here, the target track may be modified by changing the curvature in the track.

The driving assistance device may further include vehicle behavior control means for controlling vehicle behavior, wherein a control intervention ratio may be changed by the vehicle behavior control means based on the detected driver's intention and the obtained variable area. The vehicle behavior control means may be steering property change means for changing the steering property.

The driving assistance device may further include: vehicle behavior control means for controlling vehicle behavior; anticipated curvature calculation means for obtaining an anticipated curvature of a travel path based on the detected driver's intention; and curvature comparison means for comparing the obtained anticipated curvature and a curvature of the path obtained by the path information acquisition means, wherein a control condition may be changed by the vehicle behavior control means based on the comparison result.

### Advantageous Effects of Invention

According to the present invention, it is possible to give flexibility of self-control by selecting the travel path depending on a driver's requested target, for example, which of time or fuel consumption is a priority, calculating the target track to be achieved by the vehicle on the established travel path, and obtaining a variable area as a changeable area thereof.

Here, a driver can feel less uncomfortable if the driving assistance is controlled or the target track is modified according to driver's intention manipulation after the driver's intention of manipulation or the like is identified. Additionally, when the vehicle behavior is controlled, the driver can feel less uncomfortable by adjusting the control intervention ratio.

It is possible to perform the control suitable for driver's intention by performing a behavior control using the vehicle behavior control means by comparing the path curvature with the curvature of the track that the driver is set to take from the driver's intention of manipulation.

### BRIEF DESCRIPTION OF DRAWINGS

FIG. 1 is a block diagram illustrating a configuration of the driving assistance device according to the present invention;

FIG. 2 is a diagram illustrating control images in the control marginal field for controlling of the related art and of the present invention;

FIG. 3 is a flowchart illustrating a first control process in the driving assistance device according to the present invention;

FIG. 4 is a flowchart illustrating a second control process in the driving assistance device according to the present invention;

FIG. 5 is a diagram illustrating a gain setting example in the controlling of FIG. 4;

FIG. 6 is a flowchart illustrating a modification of the second control process;

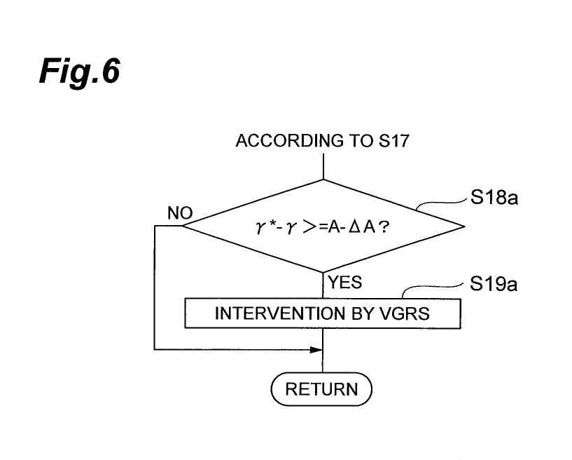

FIG. 7 is a flowchart illustrating a third control process in the driving assistance device according to the present invention;

FIG. 8 is a diagram illustrating target track setting in the control process of FIG. 7; and

FIG. 9 is a flowchart illustrating a fourth control process in the driving assistance device according to the present invention.

### DESCRIPTION OF EMBODIMENTS

Hereinafter, preferable embodiments of the present invention will be described with reference to the accompanying drawings. In order to facilitate understanding of description, same reference numerals in each of diagrams denote same components, and description thereof will not be repeated.

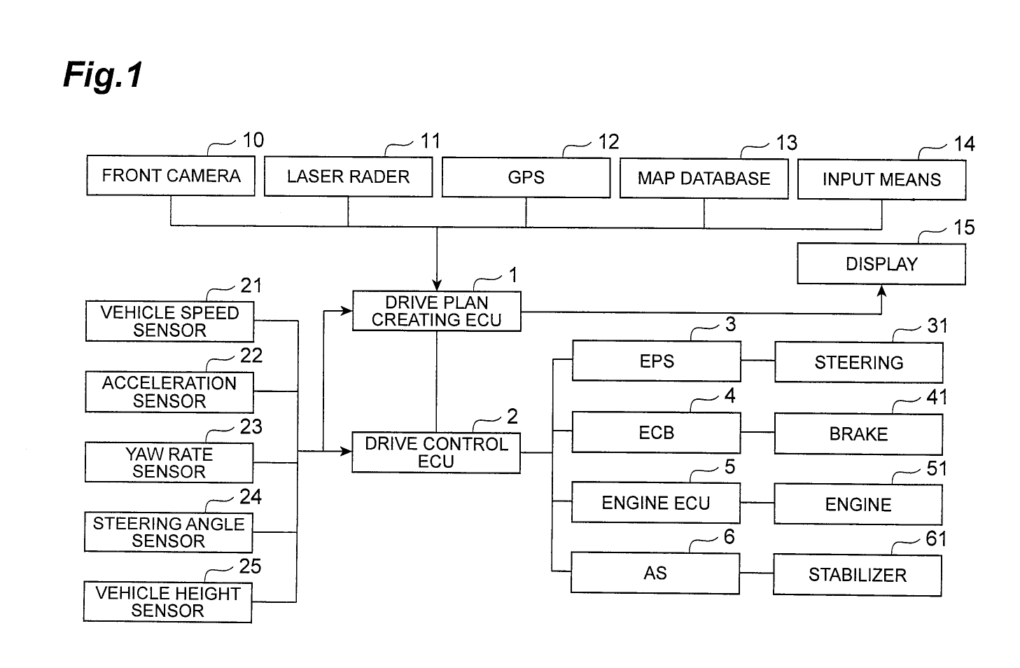

FIG. 1 shows a block diagram illustrating a driving assistance device according to the present invention. In the assistance device, a control unit includes a driving plan creating electronic control unit (ECU) 1 and a motion control ECU 2. Each of the ECU 1 and ECU 2 includes a CPU, a ROM, a RAM, and the like. The driving plan creating ECU 1 and the motion control ECU 2 are connected to each other via a LAN or a BUS in the vehicle and serves to perform mutual communication.

The driving plan creating ECU 1 receives output from the front camera 10 for obtaining a front image of the vehicle, a laser radar 11 for detecting obstacles or the like in front of the vehicle, a global positioning system (GPS) 12 for obtaining positional information of a host vehicle, a map database (DB) 13 for storing map information such as road information, and an input means 14 such as a keyboard and a touch panel and outputs the created driving plan on the display 15 as navigation information. Various autonomous navigation systems may be employed in addition to the GPS 12.

Both the driving plan creating ECU 1 and the motion control ECU 2 receive each output from a vehicle speed sensor 21 for detecting a vehicle velocity, an acceleration sensor 22 for detecting an acceleration applied to the vehicle, a yaw rate sensor 23 for detecting a yaw rate applied to the vehicle, a steering angle sensor 24 for detecting a steering angle of the vehicle, and a vehicle height sensor 25 for detecting the vehicle height.

The motion control ECU 2 communicates with an electric power steering (EPS) 3 for controlling the steering 31, an electronically controlled brake (ECB) system 4 for controlling a brake 41, an engine ECU 5 for controlling an engine 51, and an active stabilizer (AS) 6 for controlling a stabilizer 61 for adjusting the vehicle height, and controls the vehicle behavior by controlling operations of each element. The engine 51 is not limited to an internal combustion engine and may include an electric motor system or a hybrid system including both the internal combustion engine and the electric motor.

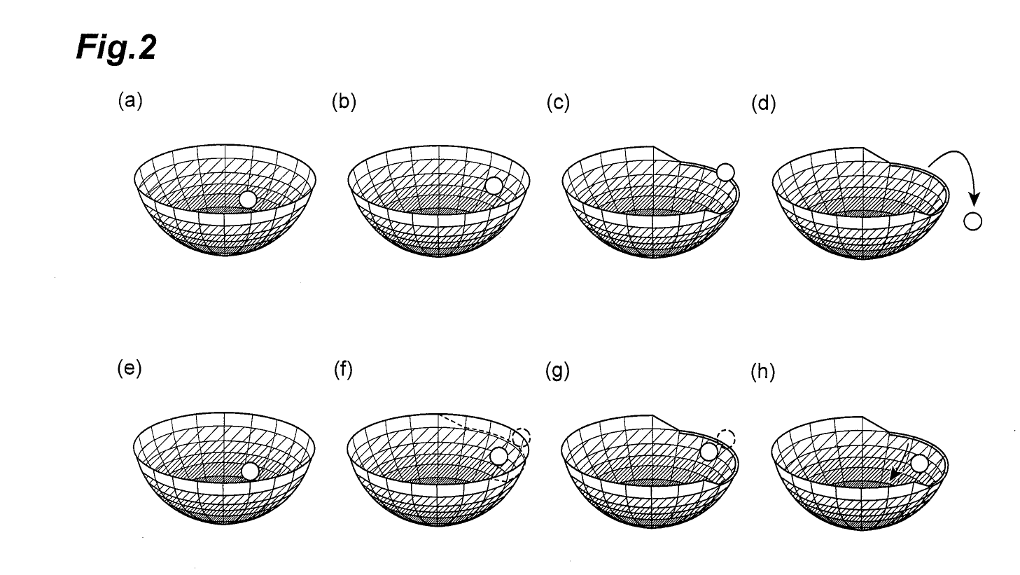

FIG. 2 is an image illustrating control of the present invention in comparison with control of the related art. Here, the vehicle behavior is approximated to behavior control of a ball inside a bowl-like container. As the ball is closer to the bottom of the container, the vehicle behavior is in the general region. As the ball is closer to the verge of the container, the vehicle behavior is in the marginal region.

FIGS. 2A to 2D are images illustrating control of the related art, and the control advances sequentially in the order of FIG. 2A, FIG. 2B, FIG. 2C, and FIG. 2D. Since control of the related art does not have enough information regarding the control limitation, when the ball arrives at a control marginal field (FIG. 2C), the behavior tends to fail (FIG. 2D). FIGS. 2E to 2H illustrate images of control according to the present invention. In this control, since the vehicle behavior (ball illustrated as a solid line) is controlled so as not to be close to the marginal region using the preview information (the ball illustrated as a dotted line) indicating the marginal region of the vehicle behavior, the behavior can advance into the general region without a large disturbance of vehicle behavior. Hereinafter, operations of the driving assistance device according to the present invention will be described in detail.

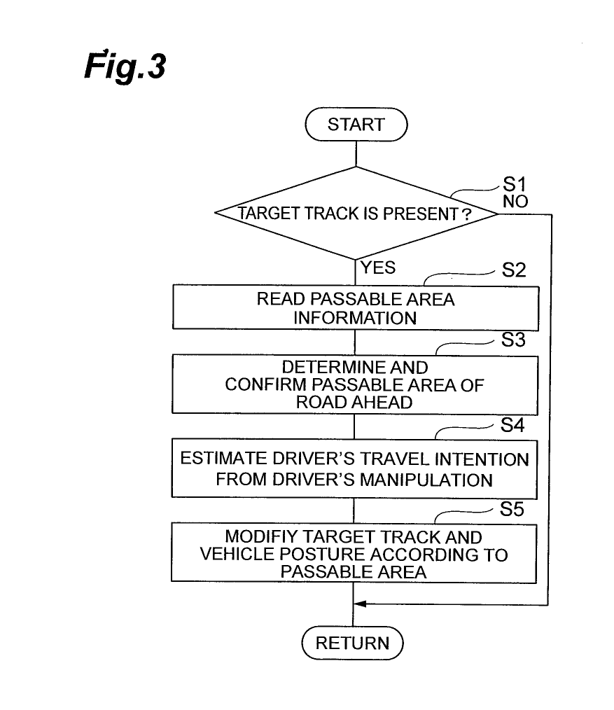

(First Processing Mode) FIG. 3 is a flowchart illustrating a first control process as a basic configuration. This process is repeatedly performed at a predetermined timing while the power key of the vehicle is turned on, in cooperation with the driving plan creating ECU 1 and the motion control ECU 2.

In step S1, it is determined whether or not the target track is already set. This target track is created by the driving plan creating ECU 1. The path to the destination (indicating which roads and intersection points are passed to the destination) is set based on travel lane information obtained through white line recognition using the image processing from the front road images obtained from the front camera 10, information on obstacles in front of the vehicle, obtained from the laser radar 11, information on the current position of the vehicle, obtained from the GPS 12, information on roads or paths to the destination, obtained from the map DB 13, a target relating to the path set by a driver using the input means 14, that is, including the destination and a request of the travel method to the destination (whether priority is given to time or fuel consumption) and the like, a target track is set as a track to pass through the rear wheel shaft center of the host vehicle within that path. The target track is set as, for example, a track passing through the center line of the travel lane in the initial setting.

If the target track is not set, the subsequent processes are skipped, and the process is terminated. Otherwise, if the target is set, the process advances to step S2 and obtains the passable area information (step S2). The passable area information includes the width information of the travel lane for the section ahead read from the map DB 13, the width information actually measured based on the travel lane information obtained from the front camera 10, the undetected obstacle from the laser radar 11, the velocity and the positional information of the preceding vehicle, and the like.

Then, the passable area in the road ahead is determined and confirmed based on the obtained passable area information (step S3). The passable area, within which the host vehicle can safely travel, is set based on the driving conditions of the host vehicle including the vehicle velocity, the width of the travel lane, the distance between the host vehicle and the preceding vehicle, and the presence of neighboring obstacles (for example, presence of a stopped vehicle).

Subsequently, driver's intention of travel is estimated from the driver's manipulation state (step S4). The intention of manipulation such as the driver's lane change, the acceleration and deceleration, and the positioning within a travel lane is estimated based on the manipulation state including the acceleration and deceleration of the vehicle accompanied by the accelerator, the brake, and the shift manipulation. In step S5, based on the estimated driver's intention, the target track-vehicle posture is modified according to the passable area, and the process is terminated.

In this manner, it is possible to provide a target track where the driver has no uncomfortable feeling by modifying the established target track according to the passable area based on the estimated driver's intention of travel. Therefore, if vehicle behavior control is performed by referencing the target track, it is possible to perform control such that a driver does not feel uncomfortable for the control intervention, driver manipulation and the control intervention are not mutually exclusive, and control is performed so as not to be close to a marginal region that may cause a control failure.

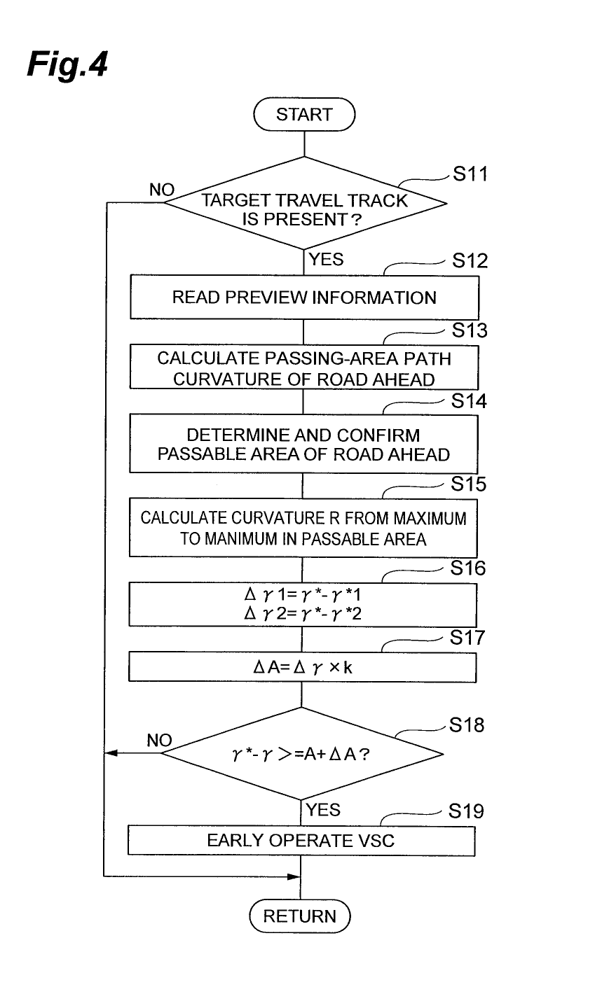

(Second Processing Mode) FIG. 4 is a flowchart illustrating the second processing mode. Similar to the first control process, the second control process is performed repeatedly at a predetermined timing while the power key of the vehicle is turned on, in cooperation with the driving plan creating ECU 1 and the motion control ECU 2.

In the initial step S11, it is determined whether or not the target travel track exists. The target travel track is similar to the target orbit of the first processing mode. If the target travel track is not set, the process is terminated by skipping the subsequent processes. Otherwise, if the target travel track is set, the process advances to step S12, and the preview information is obtained. The preview information represents the marginal region of the vehicle behavior and is used to limit the velocity pattern, the acceleration and deceleration pattern, the yaw rate change pattern, or the like based on the conditions of the travel road and the vehicle in advance.

In step S13, the path curvature of the passing area of the path ahead is calculated. The path curvature may be obtained from the travel lane information of the section ahead read from the map DB 13 or the travel lane information obtained from the front camera 10. Then, similar to step S3 of the first process, the passable area of the previous road is determined and confirmed (step S14). The maximum curvature Rmax and the minimum curvature Rmin are obtained in the confirmed passable area (step S15).

Then, the target yaw rate γ* obtained by fixing the target steering angle δ at the time of planning, the target yaw rate γ*1 corresponding to the obtained maximum curvature Rmax, and the target yaw rate γ*2 corresponding to the minimum curvature Rmin are obtained. The difference Δγ1 between γ* and γ*1, and the difference Δγ2 between γ* and γ*2 are obtained (step S16).

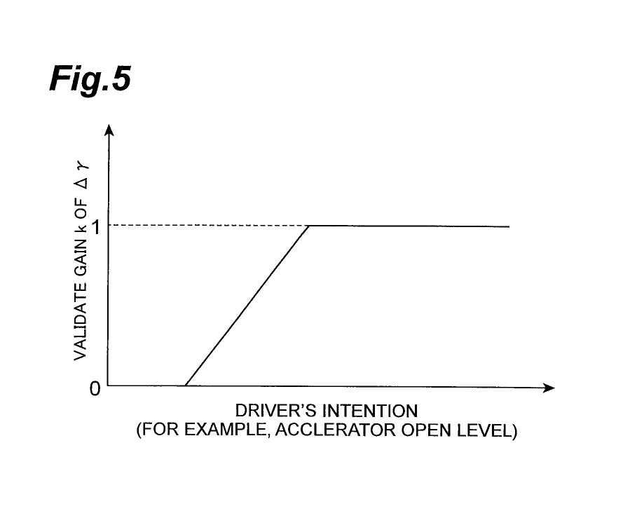

Then, the intervention amount ΔA is set (step S17). ΔA is set by multiplying Δγ by a predetermined gain k. Here, as Δγ, a curvature in the direction where the intervention control is performed in practice is used out of the Δγ1 and Δγ2 obtained from step S16. For example, if the control is performed in terms of the maximum curvature from the planning, Δγ1 is used. If the control is performed in terms of the minimum curvature from the planning, Δγ2 is used. The gain k varies depending on driver's intention, and is set, for example, depending on the accelerator open level as shown in FIG. 5.

Then, in step S18, it is determined whether or not the intervention is performed. Specifically, it is determined whether or not the difference between the current yaw rate γ and the target yaw rate γ* obtained from the yaw rate sensor 23 is equal to or higher than the value obtained by adding the intervention amount ΔA to the standard threshold value A. If the value is γ−γ* but lower than A+ΔA, it is determined that it is not necessary to perform the control intervention, and the process is terminated by skipping the subsequent processes. Otherwise, if γ−γ* is equal to or higher than A+ΔA, it is determined that it is necessary to perform the control intervention, and the vehicle stability control (VSC) is activated early. Specifically, as the control of VSC, it is determined based on the vehicle posture whether the vehicle is in an oversteering state or an understeering state. If it is determined that the vehicle is at the oversteering state, a brake on the outer front wheel is applied. In comparison, if it is determined that the vehicle is at the understeering state, the engine power is lowered, and a brake on the inner rear wheel is applied. In this case, a criterion for determining the oversteering or the understeering is set such that earlier control can be performed in comparison with a typical case. According to the present embodiment, it is possible to perform the VSC intervention control such that the original steering characteristics of the vehicle can be exhibited.

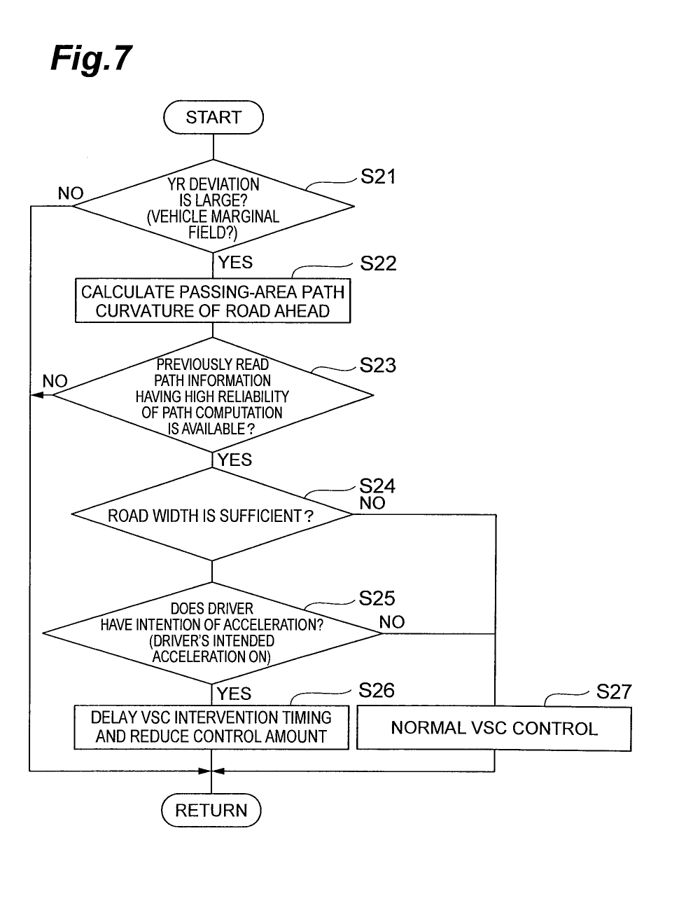

Although the control of steps S18 and S19 is to perform passive control intervention, active control intervention may be performed. In the flowchart of FIG. 7, the process of steps S18 and S19 is changed. The intervention determination in step S18a is different from that of step S18 in terms of the threshold value of the intervention determination. In addition, it is determined whether or not the difference between the current yaw rate γ and the target yaw rate γ* obtained from the yaw rate sensor 23 is equal to or higher than a value obtained by subtracting the intervention amount ΔA from the standard threshold value A.

If γ−γ* is lower than A−ΔA, it is determined that it is not necessary to perform the control intervention, and the process is terminated by skipping the subsequent processes. Otherwise, if γ−γ*is equal to or higher than A−ΔA, it is determined that it is necessary to perform the control intervention, and the active intervention control is performed based on variable gear ratio steering (VGRS). Specifically, as the specific VGRS control, the steering angle capable of realizing the target yaw rate is more rapidly advanced by changing the actual steering angle for the manipulation of the steering 31.

(Third Processing Mode) FIG. 7 is a flowchart illustrating a third processing mode. Initially, it is determined whether or not the vehicle is in the vehicle marginal field by determining the yaw rate deviation Δγ (step S21). The yaw rate deviation Δγ is the difference between the target yaw rate γ* and the actual yaw rate γ. If the absolute value of Δγ is equal to or higher than a predetermined threshold value, it is determined that the vehicle is in the control marginal field (vehicle marginal field).

If it is determined that the vehicle is not in the vehicle marginal field, typical vehicle behavior control can be applied so that the process is terminated by skipping the subsequent processes. Otherwise, if it is determined that the vehicle is in the vehicle marginal field, the process advances to step S22, and the passing-area path curvature of the road ahead is calculated. The calculation of the passing-area path curvature is similar to that of step S13 in the second processing mode.

Then, the reliability of the path calculation is validated (step S23). The reliability of the anticipated path is determined by a combination of the path information obtained from the map DB 13 and the path information obtained from the front camera 10 and the like, or the actual travel result. If it is determined that the path information read from map DB 13 or the like in advance is not reliable, the process is terminated by skipping the subsequent processes. Otherwise, if it is determined that it is reliable, the process advances to step S24.

In step S24, the road width is determined. Although the determination is made by comparing the road width obtained from path information with a predetermined threshold value, the threshold value may be set higher as a vehicle velocity and a road curvature increase. If it is determined that the road width is narrower than the threshold value and is insufficient, the process advances to step S27 which will be described below. If it is determined that the road width is equal to or wider than the threshold value and is sufficient, the process advances to step S25.

In step S25, driver's intention of acceleration is determined. The determination may be performed by determining whether or not the accelerator manipulation is performed by a driver. If the accelerator manipulation is not performed, the process advances to step S27. Otherwise, if the accelerator manipulation is performed, the process advances to step S26.

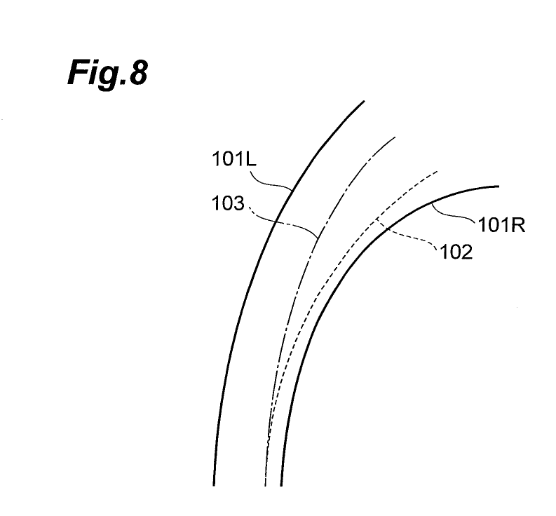

In step S26, since the road width is sufficient, and the control is possibly performed depending on driver's intention of acceleration, the intervening timing of the VSC is delayed in comparison with a typical case, and the control amount is reduced. As a result, in the road (101L and 101R denote boundary lines) of FIG. 8, the original target track 102 can be modified to the target track 103 reflecting the driver's intention.

Otherwise, if the road width is insufficient, or if the driver does not have the acceleration intention, the normal VSC control is performed in step S27. In this case, on the road of FIG. 8, the vehicle behavior control is performed such that the vehicle travels along the original target track 102.

According to the present invention, the control can be cooperatively performed based on the vehicle behavior control and the driver's intention within the control marginal field, and the driver does not feel uncomfortable with the control.

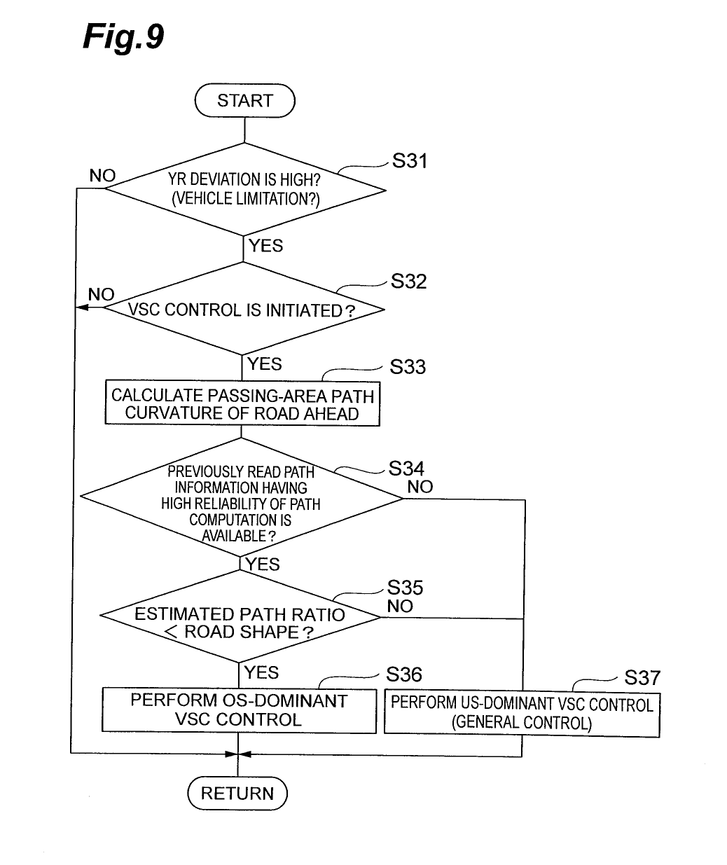

(Fourth Processing Mode) FIG. 9 is a flowchart illustrating a fourth processing mode. Initially, it is determined whether or not the vehicle is in the vehicle marginal field by determining the yaw rate deviation Δγ (step S31). This process is similar to the process of step S21 in the third processing mode.

If it is determined that the vehicle is not in the vehicle marginal field, typical vehicle behavior control can be applied so that the process is terminated by skipping the subsequent processes. Otherwise, if it is determined that the vehicle is in vehicle marginal field, the process advances to step S32, and it is determined whether or not the VSC control is initiated. If the VSC control is not performed, the process is terminated by skipping the subsequent processes. Otherwise, if the VSC control is performed, the process advances to step S33.

In step S33, the passing-area path curvature of the road ahead is calculated. The calculation of the passing-area path curvature is similar to the process of step S13 in the second processing mode and the process of step S22 in the third processing mode.

Then, the reliability of the path calculation is validated (step S34). This process is similar to the process of step S23 in the third processing mode. If it is determined that the path information read in advance from the map DB 13 or the like is not reliable, the process advances to step S37 described below. Otherwise, if it is determined that the path information is reliable, the process advances to step S35.

In step S36, the anticipated path curvature is compared with the path curvature based on the actual road shape. Here, the path curvature based on the actual road shape refers to a curvature of the path through which the vehicle can pass in the area where the vehicle can substantially travel by avoiding obstacles and the like and may be changed depending on a travel state of the vehicle (such as the vehicle velocity, acceleration, and the yaw rate). If the anticipated path curvature is smaller than the path curvature based on the road shape, that is, if the curve side in the area the vehicle can substantially travel is sharper than that of the anticipated path, the process advances to step S36, and oversteering-dominant control is performed in the VSC control such that the control is performed in response to the sharp curve.

Otherwise, if the path information read from step S34 in advance is not reliable, and if the anticipated path curvature is higher than the path curvature based on the road shape, and the curve side in the area where the vehicle can substantially travel is more gentle than that of the anticipated path, understeering-dominant control, which is general in the VSC control, is performed.

According to the present embodiment, it is possible to perform the vehicle behavior control within the control marginal field and the driver's intention based control cooperatively and decrease a driver's feeling of discomfort with the control.

The aforementioned process flowcharts of each control are just exemplary and may be changed properly. Additionally, a part of or all of each ECUs may be shared with each other or with other control devices.

### REFERENCE SIGNS LIST

1: DRIVING PLAN CREATING ECU
2: MOTION CONTROL ECU
10: FRONT CAMERA
11: LASER RADAR
12: GPS
13: MAP DB,
14: INPUT MEANS
15: DISPLAY
21: VEHICLE SPEED SENSOR
22: ACCELERATION SENSOR
23: YAW RATE SENSOR
24: STEERING ANGLE SENSOR
25: VEHICLE HEIGHT SENSOR
31: STEERING
41: BRAKE
51: ENGINE
61: STABILIZER
101L, 101R: ROAD BOUNDARY LINE
102, 103: TARGET TRACK

1.-7. (canceled)

8. A driving assistance device comprising:
path target acquisition means for obtaining a driver requested target at the time of travel path setting;
path selection means for selecting a travel path according to the acquired target;
path information acquisition means for obtaining path information of the selected path;
target track computation means for calculating a target track of a vehicle on the selected path;
variable area calculation means for determining a passable area of the vehicle on the path based on the path information and obtaining a variable area, a range in which change is allowed, of the track calculated based on the passable area;
driver's intention estimation means for estimating intention of travel based on a driver's manipulation state;
modification means for modifying the target track or a support manipulation depending on the obtained variable area based on the estimated driver's intention of manipulation when a path movement support is performed based on the established target track.

9. The driving assistance device according to claim 8, wherein the target track is modified using the modification means by changing a curvature in the track.

10. The driving assistance device according to claim 8, further comprising vehicle behavior control means for controlling the vehicle behavior, wherein the modification means changes the control intervention ratio by the vehicle behavior control means based on the estimated driver manipulation volition and the obtained variable range.

11. The driving assistance device according to claim 10, wherein the vehicle behavior control means is steering property change means for changing the steering property.

12. The driving assistance device according to claim 8, further comprising:
vehicle behavior control means for controlling vehicle behavior;
anticipated curvature calculation means for obtaining an anticipated curvature of a travel path based on the detected driver volition; and
curvature comparison means for comparing the obtained anticipated curvature and a curvature of the path obtained by the path information acquisition means,
wherein a control condition is changed by the vehicle behavior control means based on the comparison result.
